(19) United States
(12) Patent Application Publication
(10) Pub. No.: US 2012/0026155 A1
(43) Pub. Date: Feb. 2, 2012

(54) ORGANIC LIGHT EMITTING DISPLAY

(76) Inventors: Naoaki Komiya, Yongin-city (KR); Jang-Doo Lee, Yongin-city (KR)

(21) Appl. No.: 13/013,658

(22) Filed: Jan. 25, 2011

(30) Foreign Application Priority Data
Jul. 27, 2010 (KR) 10-2010-0072428

(51) Int. Cl. G09G 3/30; G09G 5/00

(52) U.S. Cl. 345/213; 345/76

(57) ABSTRACT

There is provided an organic light emitting display. The organic light emitting display includes a display unit including pixels coupled to scan lines, control lines, and data lines; a control line driver for providing control signals to the pixels through the control lines; a scan driver for providing scan signals to the pixels through the scan lines; a data driver for providing data signals to the pixels through the data lines; a first power source driver for applying a first power to the pixels of the display unit; a second power source driver for applying a second power to the pixels of the display unit; and a timing controller for controlling the control line driver, the power source drivers, the scan driver, and the data driver. The timing controller is configured to determine a refresh rate of input data to control a length of an emission period in a frame.

### CROSS-REFERENCE TO RELATED APPLICATION

This application claims priority to and the benefit of Korean Patent Application No. 10-2010-0072428, filed on Jul. 27, 2010, in the Korean Intellectual Property Office, the entire content of which is incorporated herein by reference.

### BACKGROUND

1. Field

Aspects of embodiments according to the present invention relate to an organic light emitting display.

2. Description of the Related Art

Recently, various flat panel displays (FPDs) having reduced weight and volume when compared to that of cathode ray tube (CRT) devices have been developed. The FPDs include liquid crystal displays (LCDs), field emission displays (FEDs), plasma display panels (PDPs), and organic light emitting displays.

Among the FPDs, the organic light emitting displays display images using organic light emitting diodes (OLEDs) that generate light by re-combination of electrons and holes. The organic light emitting display has high response speed and is driven with low power consumption.

In general, an OLED display is classified as a passive matrix type OLED (PMOLED) display or an active matrix type OLED (AMOLED) display according to a method of driving the OLEDs. The AMOLED display includes a plurality of gate lines, a plurality of data lines, a plurality of power source lines, and a plurality of pixels coupled to these lines and arranged in a matrix. In addition, each of the pixels includes an OLED, two transistors (that is, a switching transistor for transmitting a data signal and a driving transistor for driving the electroluminescent (EL) element in accordance with the data signal), and a capacitor for maintaining the data voltage.

The AMOLED display has small power consumption. However, the intensity of current that flows through each OLED varies with a variation in a voltage between the gate and source of the driving transistor for driving the OLED, that is, a variation in the threshold voltage of the driving transistor, to cause non-uniformity in the display.

That is, since the characteristics of the transistors provided in each of the pixels vary with manufacturing process variables, it is difficult to manufacture the transistors so that the characteristics of all of the transistors of the AMOLED display are the same. Therefore, a variation in the threshold voltages of the pixels exists.

Recently, in order to address such a problem, research on a compensation circuit including a plurality of transistors and capacitors has been performed. The problem can then be solved or reduced by forming the compensation circuit in each of the pixels. However, in this case, a large number of transistors and capacitors are formed in each of the pixels. More specifically, when the compensation circuit is added to each of the pixels, the transistors and capacitors that constitute each of the pixels and the signal lines for controlling the transistors are added so that, in the case of the AMOLED display using a lower part emission method, an aperture ratio is reduced and a possibility of manufacturing defects increases as the complexity of the circuits increases.

In addition, recently, in order to remove a motion blur phenomenon in applications such as shutter glasses type three-dimensional (3D) displays, high-speed scan driving of at least 120 Hz is required. However, in this case, the charge time for each of the scan lines is significantly reduced. That is, when the compensation circuit is provided in each of the pixels so that a large number of transistors are formed in each of the pixels coupled to one scan line, capacitive load increases. As a result, it is difficult to realize the high speed scan driving.

### SUMMARY

Accordingly, aspects of embodiments according to the present invention address these concerns by providing an organic light emitting display and a method of driving an organic light emitting display that are capable of controlling the emission period in one frame period in accordance with (e.g., to correspond to) the refresh rate of input data in order to reduce power consumption in driving the organic light emitting display by a concurrent (e.g., simultaneous) emission method.

In an exemplary embodiment according to the present invention, an organic light emitting display is provided. The organic light emitting display includes a display unit, a control line driver, a scan driver, a data driver, a first power source driver, a second power source driver, and a timing controller. The display unit includes pixels. The pixels are coupled to scan lines, control lines, and data lines. The control line driver is for providing control signals to the pixels through the control lines. The scan driver is for providing scan signals to the pixels through the scan lines. The data driver is for providing data signals to the pixels through the data lines. The first power source driver is for applying a first power to the pixels of the display unit. The second power source driver is for applying a second power to the pixels of the display unit. The timing controller is for controlling the control line driver, the first power source driver, the second power source driver, the scan driver, and the data driver. The timing controller is configured to determine a refresh rate of input data to control a length of an emission period in a frame.

At least one of the first power or the second power may be applied to the pixels of the display unit with different voltage values during the frame.

The control signals and the first and second powers may be concurrently provided to the pixels of the display unit.

The timing controller may be configured to control an application point of time or period at which the first and second powers are concurrently provided during the emission period.

When the input data has a low refresh rate, the emission period may be at least three times longer than when the input data has a high refresh rate.

The scan signals may be sequentially applied to the scan lines in a partial period of the frame and may be concurrently applied to the scan lines in periods of the frame other than the partial period.

The data signals may be sequentially applied to the pixels coupled to the scan lines in accordance with the sequentially applied scan signals during the partial period of the frame, and may be concurrently applied to the pixels through the data lines in the periods of the frame other than the partial period.

Each of the pixels may include a first transistor, an organic light emitting diode (OLED), a second transistor, a first capacitor, a second capacitor, and a third transistor. The first transistor has a gate electrode coupled to a corresponding one of the scan lines, a first electrode coupled to a corresponding one of the data lines, and a second electrode coupled to a first node. The OLED has a cathode electrode for receiving the second power. The second transistor has a gate electrode coupled to a second node, a first electrode for receiving the first power, and a second electrode coupled to an anode electrode of the OLED. The first capacitor is coupled between the first node and the first electrode of the second transistor. The second capacitor is coupled between the first node and the second node. The third transistor has a gate electrode coupled to a corresponding one of the control lines, a first electrode coupled to the gate electrode of the second transistor, and a second electrode coupled to the second electrode of the second transistor.

The first, second, and third transistors may be PMOS transistors.

When the first power and the control signals are applied to the pixels at a high level and the second power is applied to the pixels at a low level, the pixels may concurrently emit light with brightness corresponding to the data signals previously stored in the pixels.

A period in which the second power is applied at the low level may be controlled in accordance with the refresh rate of the input data.

In another exemplary embodiment according to the present invention, a method of driving an organic light emitting display is provided. The method includes: concurrently applying a first power, a second power, scan signals, control signals, and data signals to pixels that constitute a display unit to reduce a voltage of an anode electrode of an OLED included in each of the pixels to no more than a voltage of a cathode electrode of the OLED; concurrently applying the first power, the second power, the scan signals, the control signals, and the data signals to the pixels to store a threshold voltage of a driving transistor provided in each of the pixels; sequentially applying the scan signals to the pixels coupled to scan lines of the display unit and applying the data signals to the pixels coupled to the scan lines in accordance with the sequentially applied scan signals; and concurrently applying the first power, the second power, the scan signals, and the control signals to the pixels so that the pixels concurrently emit light with brightness corresponding to data voltages stored in the pixels. A length of an emission period is controlled in accordance with a refresh rate of input data.

When the input data has a low refresh rate, the emission period may be at least three times longer than when the input data has a high refresh rate.

The method may further include concurrently applying the first power, the second power, the scan signals, the control signals, and the data signals to the pixels before performing resetting to initialize voltages of nodes of pixel circuits provided in the pixels.

The method may further include concurrently applying the first power, the second power, the scan signals, and the control signals to the pixels after the emission period to reduce the voltage of the anode electrode included in each of the pixels and to turn off emission.

In driving the organic light emitting display by the concurrent (e.g., simultaneous) emission method, the emission period in one frame is controlled in accordance with the refresh rate of the input data so that power consumption may be reduced.

### BRIEF DESCRIPTION OF THE DRAWINGS

The accompanying drawings, together with the specification, illustrate exemplary embodiments of the present invention, and, together with the description, serve to explain the principles and/or aspects of the present invention.

FIG. 1 is a block diagram illustrating an organic light emitting display according to an embodiment of the present invention;

FIG. 2 is a timeline view illustrating the driving operations of a concurrent (e.g., simultaneous) emission method according to an embodiment of the present invention;

FIG. 3 is a timeline view illustrating a driving operation of an example shutter glasses type three dimensional (3D) display by using a conventional progressive emission method;

FIG. 4 is a timeline view illustrating a driving operation of an example shutter glasses type 3D display by using the concurrent (e.g., simultaneous) emission method according to an embodiment of the present invention;

FIGS. 5A and 5B are timeline views illustrating exemplary driving operations of the organic light emitting display according to embodiments of the present invention;

FIG. 6 is a circuit diagram illustrating the structure of the pixel of FIG. 1 according to an embodiment of the present invention; and

FIG. 7 is a timing diagram illustrating the timing of the signals of the pixel of FIG. 6.

### DETAILED DESCRIPTION

Hereinafter, certain exemplary embodiments according to the present invention will be described with reference to the accompanying drawings. Here, when a first element is described as being coupled or connected to a second element, the first element may be directly coupled to the second element or may be indirectly coupled to the second element via one or more third elements. Further, some of the elements that are not essential to a complete understanding of the described embodiments of the invention may be omitted for clarity. In addition, like reference numerals refer to like elements throughout.

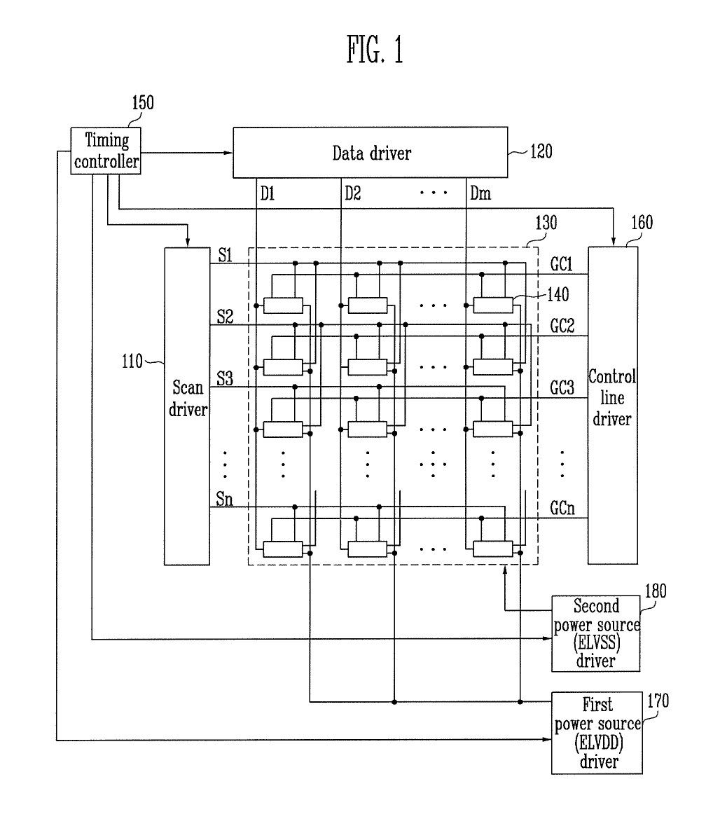

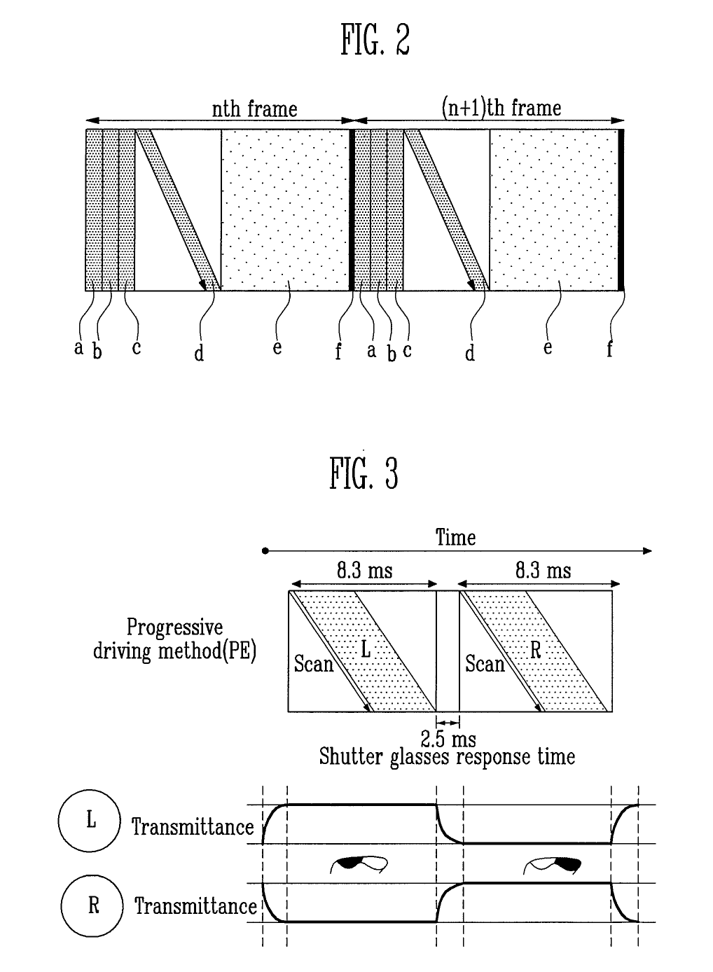

FIG. 1 is a block diagram illustrating an organic light emitting display according to an embodiment of the present invention. FIG. 2 is a timeline view illustrating the driving operations of a concurrent (e.g., simultaneous) emission method according to an embodiment of the present invention.

Referring to FIG. 1, the organic light emitting display includes a display unit 130 including pixels 140 coupled to scan lines S1 to Sn, control lines GC1 to GCn, and data lines D1 to Dm, a scan driver 110 for providing scan signals to the pixels 140 through the scan lines S1 to Sn, a control line driver 160 for providing control signals to the pixels 140 through the control lines GC1 to GCn, a data driver 120 for providing data signals to the pixels 140 through the data lines D1 to Dm, and a timing controller 150 for controlling the scan driver 110, the data driver 120, and the control line driver 160.

In addition, the display unit 130 includes the pixels 140 positioned at crossing regions of the scan lines S1 to Sn and the data lines D1 to Dm. The pixels 140 receive power from a first power source ELVDD and a second power source ELVSS from the outside. The pixels 140 control the amount of current supplied from the first power source ELVDD to the second power source ELVSS via organic light emitting diodes (OLEDs) in accordance with the data signals. Then, light having particular brightness (for example, predetermined brightness) is generated by the OLEDs.

According to an embodiment of the organic light emitting display device of FIG. 1, power from the first power source ELVDD and/or the second power source ELVSS is applied to the pixels 140 of the display unit 130 with voltage values having different levels in a period of one frame. Therefore, a first power source ELVDD driver 170 for controlling supply of the first power source voltage ELVDD and/or a second power source ELVSS driver 180 for controlling supply of the second power source voltage ELVSS are further provided. The first power source ELVDD driver 170 and/or the second power source driver 180 are controlled by the timing controller 150.

For example, in a conventional implementation, the first power source voltage ELVDD is provided as a voltage having a fixed high level and the second power source voltage ELVSS is applied to the pixels 140 of the display unit 130 as a voltage having a fixed low level. However, according to embodiments of the present invention, power from the first power source ELVDD and the second power source ELVSS is applied by techniques including the following three exemplary methods.

In the first method, the first power source voltage ELVDD is applied with voltage values having three different levels and the second power source voltage ELVSS is applied with a fixed low level (for example, ground). In this case, since the second power source ELVSS driver 180 always outputs a voltage value in a uniform level GND, the second power source ELVSS driver 180 does not need to be realized by an additional driving circuit so that circuit cost may be reduced. On the other hand, since the first power source voltage ELVDD needs a negative voltage value among the three levels, the circuit structure of the first power source ELVDD driver 170 may be complicated.

In the second method, power from each of the first power source ELVDD and the second power source ELVSS is applied with a voltage value having two levels. In this case, each of the first power source driver 170 and the second power source driver 180 is provided.

In the third method, which is opposite to the first method, the first power source voltage ELVDD is applied with a voltage value having a fixed high level and the second power source voltage ELVSS is applied with a voltage value having three different levels. In this case, since the first power source driver 170 outputs a voltage value having a uniform level, the first power source driver 170 does not need to be realized by an additional driving circuit so that circuit cost may be reduced. On the other hand, since the second power source voltage ELVSS needs a positive voltage value among the three levels, the circuit structure of the second power source ELVSS driver 180 may be complicated.

In addition, according to embodiments of the present invention, in driving the organic light emitting display, a concurrent (e.g., simultaneous) emission method is used in place of other methods, such as a progressive emission method. As illustrated in FIG. 2, data is sequentially input in a period of one frame and after input of the data is completed, illumination is collectively performed on data of one frame through the entire display unit 130, that is, all of the pixels 140 in the display unit 130. That is, in the conventional progressive emission method, data is sequentially input to the scan lines S1 to Sn and emission is sequentially performed. However, according to embodiments of the present invention, the data input is sequentially performed but emission is collectively (e.g., concurrently or simultaneously) performed after the data input is completed.

In detail, referring to FIG. 2, a driving process according to an embodiment of the present invention is divided into (a) an initializing period, (b) a resetting period, (c) a period of compensating for threshold voltages, (d) a scanning period (a period of inputting data), (e) an emission period, and (f) an emission off period. (d) The scanning period (the period of inputting data) is sequentially performed on the scan lines S1 to Sn. However, (a) the initializing period, (b) the resetting period, (c) the period of compensating for the threshold voltages, (e) the emission period, and (f) the emission off period are each concurrently (e.g., simultaneously) and collectively performed on all of the pixels 140 by the display unit 130 as illustrated in FIG. 2.

Here, (a) the initializing period is a period in which the node voltages of the pixel circuits provided in the pixels 140 are initialized in the same way as when the threshold voltages of the driving transistors are input. Further, (b) the resetting period in which the data voltages applied to the pixels 140 of the display unit 130 are reset is a period of reducing the voltages of the anode electrodes of the OLEDs to no more than the voltages of the cathode electrodes of the OLEDs so that the OLEDs do not emit light. In addition, (c) the period of compensating for the threshold voltages is a period in which the threshold voltages of the driving transistors provided in the pixels 140 are compensated for. Further, (f) the emission off period is a period in which emission is turned off for black insertion or in which dimming after emission is performed by the pixels 140.

Among the above periods, (a) the initializing period and/or (f) the emission off period may be removed. In this case, the process proceeds to (b) the resetting period, not (f) the emission off period or (a) the initializing period, of the (n+1)th frame after the (e) emission period of the nth frame, for example. In addition, when driving is performed by the above-described concurrent (e.g., simultaneous) emission method, the signals applied to (a) the initializing period, (b) the resetting period, (c) the period of compensating for the threshold voltages, (e) the emission period, and (f) the emission off period—that is, the scan signals applied to the scan lines S1 to Sn, the first power source voltage ELVDD and/or the second power source voltage ELVSS applied to the pixels 140, and the control signals applied to the control lines GC1 to GCn—are concurrently (e.g., simultaneously) and collectively applied to the pixels 140 provided in the display unit 130 using voltage levels (for example, predetermined voltage levels).

The operations of the scan driver 110, the first power source ELVDD driver 170, the second power source ELVSS driver 180, and the control line driver 160 that output the signals are controlled by the timing controller 150 as described above. That is, the point of times at which the signals are applied may be controlled by the timing controller 150.

Since the operation periods (the periods (a) to (f)) are temporally clearly divided, the transistors of the compensation circuits provided in the pixels 140 and the number of signal lines for controlling the transistors may be reduced and example devices using the organic light emitting display, for example shutter glasses type three dimensional (3D) displays, may be easily (e.g., relatively easily) realized. In the shutter glasses type 3D display, when a user looks at a screen (image display) wearing shutter glasses in which the transmittances of the left eye and the right eye are switched between 0% and 100%, the left eye image and the right eye image are alternately output from the display unit 130 of the image display. That is, the image display is an organic light emitting display onto which the image is displayed in alternating frames (left eye and right eye) so that the user looks at the left eye image only by the left eye and looks at the right eye image only by the right eye, thereby realizing a three dimensional effect.

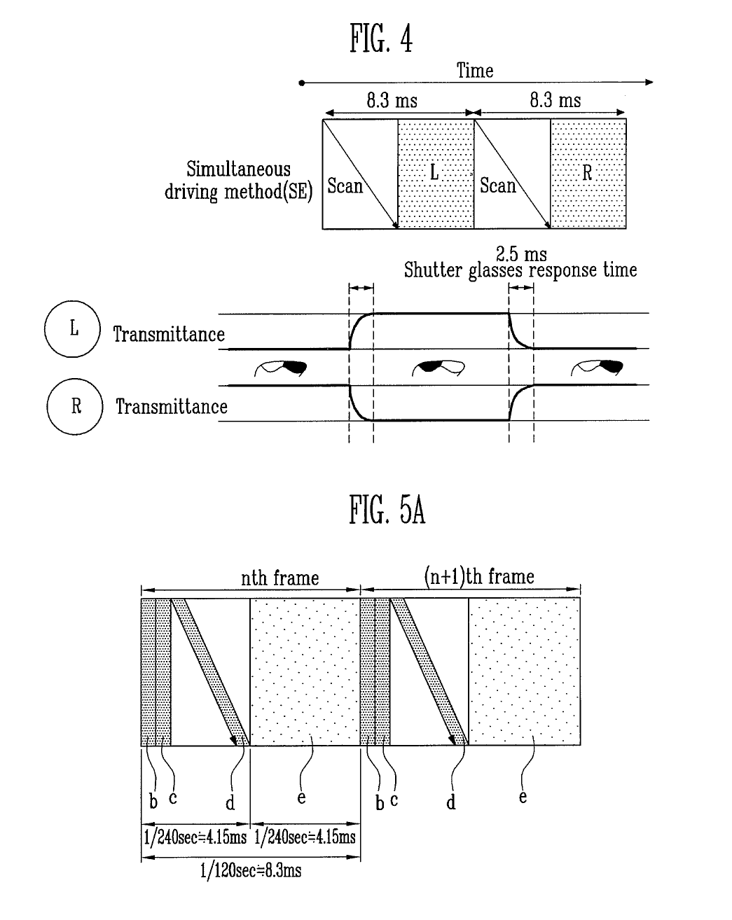

FIG. 3 is a timeline view illustrating a driving operation of an example shutter glasses type 3D display by using a conventional sequential emission method. FIG. 4 is a timeline view illustrating a driving operation of an example shutter glasses type 3D display by using the concurrent (e.g., simultaneous) emission method according to an embodiment of the present invention. In FIGS. 3 and 4, the frame rate is driven by 120 Hz. Therefore, the time of each of the frames is 1/120 sec, that is, about 8.3 ms.

In realizing the shutter glasses type 3D display, when the images are output onto the screen by the above-described conventional progressive emission method, as illustrated in FIG. 3, since the response time (that is, the time for the shutter glasses to switch from total transmittance for one eye and zero transmittance for the other eye, to zero transmittance for the one eye and total transmittance for the other eye, for example, 2.5 ms) of the shutter glasses is limited, in order to reduce or prevent a cross talk phenomenon between the left eye and the right eye, emission is turned off during the response time. That is, a non-emission period is additionally generated between a frame (an nth frame) in which the left eye image is output and a frame (an (n+1)th frame) in which the right eye image is output, the non-emission period having length that may be equal to the response time. This non-emission period causes an emission time ratio (duty ratio) to be reduced.

This non-emission period is in addition to the non-emission that takes place within the pixels of each scan line during the progressive emission. That is, each of the pixels also does not emit for a portion of time in each frame equal to the time needed to scan all of the lines (see FIG. 3). In other words, during portions of the progressive emission, only some of the pixels are emitting. This also causes the duty ratio to be reduced.

However, in the case of the concurrent (e.g., simultaneous) emission method according to an embodiment of the present invention, referring to FIG. 4, as described above, the emission period is concurrently (e.g., simultaneously) and collectively performed by all the pixels 140 of the entire display unit 130. In periods other than the emission period, non-emission is performed, during which time the shutter glasses can switch between transmitting for one eye to transmitting for the other. In other words, the response time to switch transmission between lenses of the shutter glasses can be naturally secured during the non-emission period of the concurrent (e.g., simultaneous) emission method.

For example, since light is not emitted during the emission off period, the reset period, and the threshold voltage compensating period between the emission period of the nth frame and the emission period of the (n+1)th frame, in order to synchronize the entire time of the non-emission period with the response time (for example, 2.5 ms) of the shutter glasses, unlike in the conventional progressive emission method, the emission time ratio (duty ratio) does not need to be additionally reduced. Therefore, in realizing the shutter glasses type 3D display, since the emission time ratio (duty ratio) may be secured by the concurrent (e.g., simultaneous) emission method in comparison to the conventional progressive emission method by the response time of the shutter glasses, improved performance may be realized.

The image displayed through the organic light emitting display according to embodiments of the present invention is not necessarily a moving picture of a high driving frequency (for example, 120 Hz), that is, of 3D with a high refresh rate or high picture quality. Since driving is performed by the concurrent (e.g., simultaneous) emission method, in the emission period where an image is actually displayed, as illustrated in FIG. 3, in the case where the emission period occupies ½ of each of the frames, when the driving frequency of each of the frames is 120 Hz, or 8.3 ms per frame, the emission period is only ½ of that time, or 4.15 ms per frame.

However, the displayed image is not always displayed as a moving image or a 3D image having high response speed. Display on a still screen such as images displayed during Internet browsing will likely become more commonplace. In driving an image of a frequency (for example, 60 Hz or 30 Hz) with a low data refresh rate by the above concurrent (e.g., simultaneous) driving method, driving the emission period in which the image is actually displayed in 4.15 ms periods may not be effective in terms of power consumption.

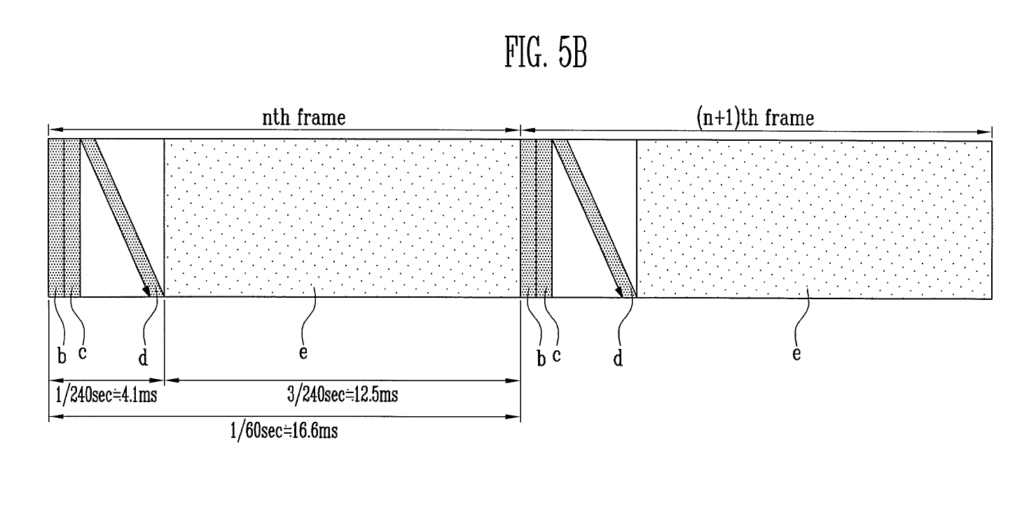

According to embodiments of the present invention, in driving the organic light emitting display by the concurrent (e.g., simultaneous) emission method, the emission period in one frame is controlled in accordance with (e.g., to correspond to) the refresh rate of input data so that power consumption is reduced. That is, when the input data is a moving picture of 3D or high picture quality with a high refresh rate, the emission period is realized to be short in order to have a sufficiently high frequency. When the input data is a still image with a low refresh rate, the emission period is realized to be long in order to have a sufficiently low frequency. The above will be described in detail with reference to FIGS. 5A and 5B.

FIGS. 5A and 5B are timeline views illustrating exemplary driving operations for comparing emission time ratios that may be obtained using the concurrent (e.g., simultaneous) emission method with two different frame rates, namely 120 Hz and 60 Hz.

In performing driving by the concurrent (e.g., simultaneous) emission method in FIG. 4, as described above, among the periods illustrated in FIG. 2 ((a) the initializing period, (b) the resetting period, (c) the period of compensating for the threshold voltages, (d) scanning period (the period of inputting data), (e) the emission period, and (f) the emission off period), (a) the initializing period and (f) the emission off period are removed.

First, referring to FIG. 5A, the driving operation in the case where the input data is 3D with a high refresh rate or a moving picture with high picture quality is illustrated. In this case, the frames are driven at a high driving frequency, for example, 120 Hz, or 8.3 ms per frame. At this time, (e) the emission period and the periods other than (e) the emission period (e.g., (b) the resetting period, (c) the period of compensating for the threshold voltage, and (d) the scanning period) are each driven for periods of 1/240 sec, or 4.15 ms per frame.

That is, one frame has a length of 1/120 sec, or about 8.3 ms, and the emission period has a length of 1/240 sec (about 4.15 ms) that is half of 1/120 sec (about 8.3 ms). The periods other than the emission period (e.g., (b) the resetting period, (c) the period of compensating for the threshold voltages, and (d) the scanning period) have a length of 1/240 sec (about 4.15 ms).

Then, referring to FIG. 5B, the driving operation in the case of a still image or other display with a low refresh rate is illustrated. In this case, each of the frames is driven by a low driving frequency, for example, 60 Hz. At this time, the periods other than the emission period (e) (e.g., (a) the initializing period, (b) the resetting period, (c) the period of compensating for the threshold voltages, and (d) the scanning period) are driven at 240 Hz to have the length of 1/240 sec (about 4.15 ms) as illustrated in FIG. 5A. The emission period in which an image is actually displayed has a length of 3/240 sec (or 12.5 ms).

Therefore, one frame has a length of 1/60 sec (about 16.6 ms) and the emission period has the length of 3/240 sec (about 12.5 ms) that is ¾ of the entire emission period. That is, when the still image with the low refresh rate is compared with the data with the high refresh rate illustrated in FIG. 5A, the length of the emission period increases at least three times.

The operation may be realized by determining the characteristic (the refresh rate) of the input data by the timing controller 150 to control the application point of time and/or period of the signals collectively provided when the emission period is driven. By the above-described driving method, the driving frequency is reduced to perform driving when the still image is displayed so that power consumption may be effectively reduced.

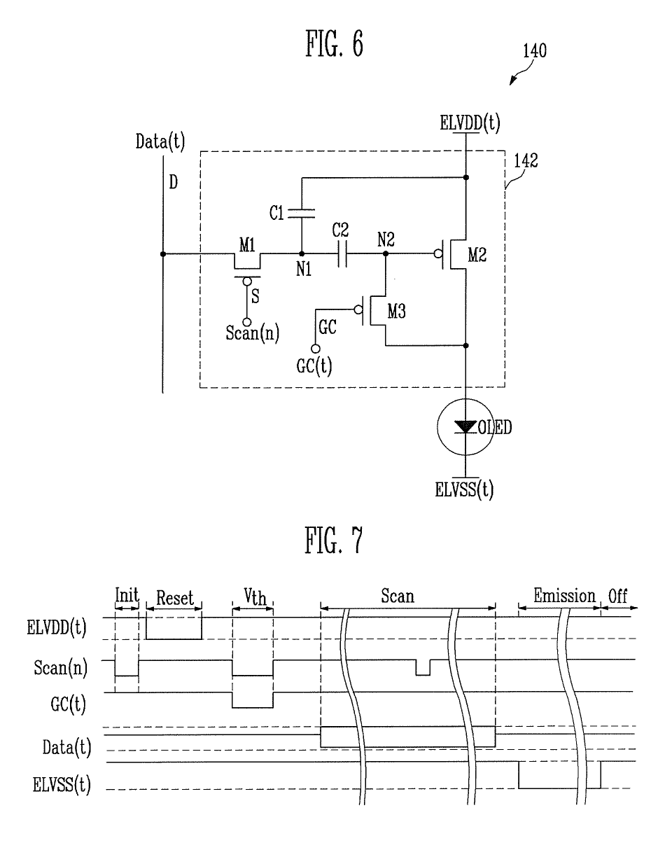

FIG. 6 is a circuit diagram illustrating the structure of a pixel 140 of FIG. 1 according to an embodiment of the present invention. FIG. 7 is a driving timing diagram illustrating the timing of the signals of the pixel of FIG. 6.

First, referring to FIG. 6, the pixel 140 includes an organic light emitting diode (OLED) and a pixel circuit 142 for supplying current to the OLED. The anode electrode of the OLED is coupled to the pixel circuit 142 and the cathode electrode of the OLED is coupled to the second power source ELVSS(t). The OLED generates light with brightness (for example, predetermined brightness) in accordance with the current supplied from the pixel circuit 142.

According to an embodiment of the present invention, the pixels 140 that constitute the display unit 130 receive the data signals supplied to the data lines D1 to Dm when the scan signals are sequentially supplied to the scan lines S1 to Sn in a partial period (the above-described period (d)) of one frame. However, in the remaining periods (e.g., the periods (a), (b), (c), (e), and (f)) of one frame, the scan signals applied to the scan lines S1 to Sn, the first power source voltage ELVDD and/or the second power source voltage ELVSS applied to the pixels 140, and the control signals applied to the control lines GC1 to GCn are concurrently (e.g., simultaneously) and collectively applied to the pixels 140 using voltage levels (for example, predetermined voltage levels).

Referring to FIG. 6, the pixel circuit 142 provided in each of the pixels 140 includes three transistors M1, M2, and M3 and two capacitors C1 and C2. A gate electrode of the first transistor M1 is coupled to the scan line S, a first electrode of the first transistor M1 is coupled to the data line D, and a second electrode of the first transistor M1 is coupled to a first node N1. The scan signal Scan(n) is input to the gate electrode of the first transistor M1 and the data signal Data(t) is input to the first electrode of the first transistor M1.

A gate electrode of the second transistor M2 is coupled to a second node N2, a first electrode of the second transistor M2 is coupled to the first power source ELVDD(t), and a second electrode of the second transistor M2 is coupled to the anode electrode of the OLED. The second transistor M2 functions as a driving transistor.

The first capacitor C1 is coupled between the first node N1 and the first electrode of the second transistor M2, that is, the first power source ELVDD(t). The second capacitor C2 is coupled between the first node N1 and the second node N2.

A gate electrode of the third transistor M3 is coupled to the control line GC, a first electrode of the third transistor M3 is coupled to the gate electrode of the second transistor M2, and a second electrode of the third transistor M3 is coupled to the anode electrode of the OLED, that is, the second electrode of the second transistor M2. The control signal GC(t) is input to the gate electrode of the third transistor M3 and, when the third transistor is turned on, the second transistor M2 is diode-coupled.

The cathode electrode of the OLED is coupled to the second power source ELVSS(t). In the embodiment illustrated in FIG. 6, the first to third transistors M1 to M3 are PMOS transistors.

As described above, the pixels 140 according to one embodiment of the present invention are driven by the concurrent (e.g., simultaneous) emission method. In detail, as illustrated in FIG. 7, each of the frames is divided into an initializing period Int, a reset period Reset, a threshold voltage compensating period Vth, a scan/data input period Scan, an emission period Emission, and an emission off period Off.

At this time, in the scan/data input period, the scan signals are sequentially input to the scan lines S1 to Sn so that the data signals can be sequentially input to the pixels 140 in accordance with the sequentially applied scan signals. However, in the other periods, signals having voltage values (for example, with predetermined levels), that is, the first power source voltage ELVDD(t) and/or the second power source voltage ELVSS(t), the scan signal Scan(n), the control signal GC(t), and the data signal Data(t), are collectively applied to the pixels 140. That is, the compensation of the threshold voltages of the driving transistors provided in the pixels 140 and the emission of the pixels 140 are concurrently (e.g., simultaneously) realized by all of the pixels 140 in the display unit 130 in each of the frames.

In one embodiment of the present invention, the first power source ELVDD(t) and/or the second power source ELVSS(t) may be provided in the above-described three methods. However, for convenience sake, in FIG. 7, the first power source ELVDD and the second power source ELVSS are applied with voltage values having two levels.

A method of driving the pixels 140 according to one embodiment of the present invention, that is, the above-described operations in the periods (the initializing period Int, the reset period Reset, the threshold voltage compensating period Vth, the scan/data input period Scan, the emission period Emission, and the emission off period Off) will be sequentially described as follows with reference to FIGS. 6 and 7.

First, in the initializing period, the first power source ELVDD(t), the second power source ELVSS(t), and the control signal GC(t) are applied at a high level and only the scan signal Scan(n) is applied at a low level. That is, in the pixel circuit illustrated in FIG. 6, only the first transistor M1 is turned on, the remaining transistors are all turned off, and the first transistor M1 is turned on so that a high level voltage as an initializing voltage is applied to the first node N1.

In addition, since the initializing period is collectively applied to the pixels 140 that constitute the display unit 130, the signals applied in the initializing period, that is, the first power source ELVDD(t), the scan signal Scan(n), the control signal GC(t), and the data signal Data(t) as the voltage values having levels (for example, predetermined levels) are concurrently (e.g., simultaneously) applied to all of the pixels 140.

All of the transistors are turned off in the initializing period, which is an optional period, that is, a period that may be removed, and then, the resetting period may be performed. That is, the scan signal Scan(n) at a high level may be applied in the initializing period.

Then, in the resetting period where the data voltages applied to the pixels 140 of the display unit 130, that is, the pixels 140 illustrated in FIG. 7 are reset, the voltages of the anode electrodes of the OLEDs are reduced to no more than the voltages of the cathode electrodes so that the OLEDs do not emit light. In the resetting period, as illustrated in FIG. 7, the first power source ELVDD(t) is applied at a low level and the second power source ELVSS(t), the scan signal Scan(n), and the control signal GC(t) are applied at a high level.

When the first power source ELVDD(t) is applied at a low level, the voltage of the first node N1 is lower than the voltage in the initializing period due to a coupling effect between the first capacitor C1 and the second capacitor C2. Therefore, the second transistor M2, which is a PMOS transistor, is turned on and a current path between the first electrode and the second electrode of the second transistor M2 is formed so that the voltage charged in the anode electrode of the OLED coupled to the first electrode of the second transistor M2 is reduced to the voltage of the first power source. That is, the anode electrode voltage of the OLED is reset.

In addition, since the resetting period is collectively applied to the pixels 140 that constitute the display unit 130, the signals applied in the initializing period, that is, the first power source ELVDD(t), the scan signal Scan(n), the control signal GC(t), and the data signal Data(t) are concurrently (e.g., simultaneously) applied to all of the pixels 140 with the voltage values (for example, with predetermined levels).

Then, the threshold voltage compensating period, in which the threshold voltage of the driving transistor M2 provided in each of the pixels 140 of the display unit 130 is stored in the second capacitor C2, reduces or removes defects caused by variation in the threshold voltage of the driving transistor when the data voltage is charged in each of the pixels 140. In the threshold voltage compensating period, as illustrated in FIG. 7, the first power source ELVDD(t) and the second power source ELVSS(t) are applied at a high level and the control signal GC(t) and the scan signal Scan(n) are applied at a low level.

When the first control signal GC(t) is applied at a low level, the third transistor M3 is turned on so that the gate electrode of the second transistor M2 and the second electrode of the third transistor M3 are electrically coupled to each other and the second transistor M2 operates as a diode. In other words, the second transistor M2 is diode-coupled. Therefore, the threshold voltage of the second transistor M2 is stored in the second capacitor C2 coupled to the second node N2 and is offset with the threshold voltage of the driving transistor (the second transistor M2) generated by the data inputting period so that defects caused by variation in the threshold voltage of the driving transistor are reduced or removed by the current applied to the OLED.

In addition, since the threshold voltage compensating period is collectively applied to the pixels 140 that constitute the display unit 130, the signals applied in the threshold voltage compensating period, that is, the first power source ELVDD(t), the scan signal Scan(n), the control signal GC(t), and the data signal Data(t) are concurrently (e.g., simultaneously) applied to all of the pixels 140 with the voltage values (for example, with predetermined levels).

After the threshold voltage compensating period, in the scan/data input period, the scan signals at a low level are sequentially input to the scan lines S1 to Sn. The data signals corresponding to the scan signals are sequentially input to the pixels 140 coupled to the scan lines S1 to Sn. In the scan/data input period, as illustrated in FIG. 7, the control signal GC(t) is applied at a high level so that the third transistor M3 is turned off. That is, in the scan/data input period, the scan signals and the data signals are applied in substantially the same manner as the concurrent (e.g., simultaneous) driving method.

In the scan/data input period, since the second power source ELVSS(t) is applied at a high level that is same as the first power source ELVDD(t), a current path is not formed between the OLED and the first power source ELVDD(t) so that current does not flow to the OLED. That is, emission is not performed. Then, in the emission period where the current corresponding to the data voltage stored in each of the pixels 140 of the display unit 130 is provided to the OLED provided in each of the pixels 140 so that emission is performed, unlike in the scan/data input periods, the second power source ELVSS(t) is applied at a low level.

Therefore, in the emission period, since the second power source ELVSS(t) is applied at a low level, as the second transistor M2 is turned on, a current path to the first power source and the cathode electrode of the OLED is formed. Therefore, the current corresponding to the voltage having a voltage value Vgs of the second transistor M2, that is, a difference between the gate electrode and the first electrode of the second transistor M2, is applied to the OLED and light is emitted with the brightness corresponding to the current.

Since the emission period is collectively applied to the pixels 140 that constitute the display unit 130, the signals applied in the emission period, that is, the first power source ELVDD(t), the scan signal Scan(n), the control signal GC(t), and the data signal Data(t) are concurrently (e.g., simultaneously) applied to all of the pixels 140 with the voltage values (for example, with predetermined levels).

In addition, as described above with reference to FIGS. 5A and 5B, according to one embodiment of the present invention, the emission period in one frame is controlled to correspond to (e.g., in accordance with) the refresh rate of the input data so that power consumption is improved. That is, when the input data is for a 3D display with a high refresh rate or a moving picture with high picture quality, the emission period is realized to be short to have the high frequency. When the input data is a still image with the low refresh rate, the emission period is realized to be long to have the low frequency.

The operation may be realized by determining the characteristic (e.g., the refresh rate) of the input data by the timing controller (150 of FIG. 1) to control the application point of time and/or period of the signals collectively provided when the emission period is driven. That is, the signals applied in the emission period, that is, the first power source ELVDD(t), the scan signals Scan(n), the control signal GC(t), and the data signal Data(t), are collectively applied to all of the pixels 140 by controlling the application period of the second power source ELVSS(t) applied at a low level.

For example, when the refresh rate of the input data is high, each of the frames is driven at 120 Hz and the second power source ELVSS(t) is applied so that the emission period has the length of 1/240 sec (about 4.15 ms). When the refresh rate is low, each of the frames is driven at 60 Hz and, in the emission period of actually displaying an image, the second power source ELVSS(t) is applied to have the length of 3/240 sec (or 12.5 ms).

That is, when the still image with the low refresh rate is compared with the data with the high refresh rate, the length of the emission period increases (e.g., at least three times). When the still image is displayed by the above driving method, driving is performed with the driving frequency reduced so that power consumption may be effectively reduced.

Then, after the emission of the display unit 130 is performed, the second power source ELVSS(t) is provided at a high level to perform the emission off period. In the emission off period where emission is turned off for black insertion or dimming, the voltage of the anode electrode of the OLED is reduced to the voltage at which emission is turned off within several hundreds microseconds (μs) when the OLED emitted light before. As described above, the emission off period may be removed.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display, comprising:
a display unit comprising pixels coupled to scan lines, control lines, and data lines;
a control line driver for providing control signals to the pixels through the control lines;
a scan driver for providing scan signals to the pixels through the scan lines;
a data driver for providing data signals to the pixels through the data lines;
a first power source driver for applying a first power to the pixels of the display unit;
a second power source driver for applying a second power to the pixels of the display unit; and
a timing controller for controlling the control line driver, the first power source driver, the second power source driver, the scan driver, and the data driver,
wherein the timing controller is configured to determine a refresh rate of input data to control a length of an emission period in a frame.

2. The organic light emitting display as claimed in claim 1, wherein at least one of the first power or the second power is applied to the pixels of the display unit with different voltage values during the frame.

3. The organic light emitting display as claimed in claim 1, wherein the control signals and the first and second powers are concurrently provided to the pixels of the display unit.

4. The organic light emitting display as claimed in claim 1, wherein the timing controller is configured to control an application point of time or period at which the first and second powers are concurrently provided during the emission period.

5. The organic light emitting display as claimed in claim 1, wherein, when the input data has a low refresh rate, the emission period is at least three times longer than when the input data has a high refresh rate.

6. The organic light emitting display as claimed in claim 1, wherein the scan signals are sequentially applied to the scan lines in a partial period of the frame and are concurrently applied to the scan lines in periods of the frame other than the partial period.

7. The organic light emitting display as claimed in claim 6, wherein the data signals are sequentially applied to the pixels coupled to the scan lines in accordance with the sequentially applied scan signals during the partial period of the frame and are concurrently applied to the pixels through the data lines in the periods of the frame other than the partial period.

8. The organic light emitting display as claimed in claim 1, wherein each of the pixels comprises:
a first transistor having a gate electrode coupled to a corresponding one of the scan lines, a first electrode coupled to a corresponding one of the data lines, and a second electrode coupled to a first node;
an organic light emitting diode (OLED) having a cathode electrode for receiving the second power;
a second transistor having a gate electrode coupled to a second node, a first electrode for receiving the first power, and a second electrode coupled to an anode electrode of the OLED;
a first capacitor coupled between the first node and the first electrode of the second transistor;
a second capacitor coupled between the first node and the second node; and
a third transistor having a gate electrode coupled to a corresponding one of the control lines, a first electrode coupled to the gate electrode of the second transistor, and a second electrode coupled to the second electrode of the second transistor.

9. The organic light emitting display as claimed in claim 8, wherein the first, second, and third transistors are PMOS transistors.

10. The organic light emitting display as claimed in claim 8, wherein, when the first power and the control signals are applied to the pixels at a high level and the second power is applied to the pixels at a low level, the pixels concurrently emit light with brightness corresponding to the data signals previously stored in the pixels.

11. The organic light emitting display as claimed in claim 10, wherein a period in which the second power is applied at the low level is controlled in accordance with the refresh rate of the input data.

12. A method of driving an organic light emitting display, comprising:
concurrently applying a first power, a second power, scan signals, control signals, and data signals to pixels that constitute a display unit to reduce a voltage of an anode electrode of an OLED included in each of the pixels to no more than a voltage of a cathode electrode of the OLED;
concurrently applying the first power, the second power, the scan signals, the control signals, and the data signals to the pixels to store a threshold voltage of a driving transistor provided in each of the pixels;
sequentially applying the scan signals to the pixels coupled to scan lines of the display unit and applying the data signals to the pixels coupled to the scan lines in accordance with the sequentially applied scan signals; and
concurrently applying the first power, the second power, the scan signals, and the control signals to the pixels so that the pixels concurrently emit light with brightness corresponding to data voltages stored in the pixels,
wherein a length of an emission period is controlled in accordance with a refresh rate of input data.

13. The method as claimed in claim 12, wherein, when the input data has a low refresh rate, the emission period is at least three times longer than when the input data has a high refresh rate.

14. The method as claimed in claim 12, further comprising concurrently applying the first power, the second power, the scan signals, the control signals, and the data signals to the pixels before performing resetting to initialize voltages of nodes of pixel circuits provided in the pixels.

15. The method as claimed in claim 12, further comprising concurrently applying the first power, the second power, the scan signals, and the control signals to the pixels after the emission period to reduce the voltage of the anode electrode included in each of the pixels and to turn off emission.
